(19) United States
(12) Patent Application Publication
(10) Pub. No.: US 2006/0256193 A1
(43) Pub. Date: Nov. 16, 2006

(54) ILLUMINATING AND IMAGE CAPTURING DEVICE FOR ORAL CAVITY

(76) Inventor: Tusng-Chuan LIU, Taipei City (TW)

Correspondence Address: LEONG C LEI, PMB # 1008, 1867 YGNACIO VALLEY ROAD, WALNUT CREEK, CA, 94598, US

(21) Appl. No.: 11/380,419

(22) Filed: Apr. 27, 2006

(30) Foreign Application Priority Data
May 10, 2005 (TW) 094207694

(51) Int. Cl. H04N 7/18; H04N 9/47

(52) U.S. Cl. 348/66; 433/217.1

(57) ABSTRACT

An illuminating and image capturing device is disclosed, which mainly contains an illuminating component providing a shadowless lighting and an image capturing component installed on a transparent cover in front of the illuminating component. The image capturing component is connected to a display for presenting its captured images and/or other devices for recording and other functions. With the additional help of a handheld mouth mirror, all details of the oral cavity can be captured and presented on the display.

### BACKGROUND OF THE INVENTION

(a) Technical Field of the Invention

The present invention generally relates to medical equipments, and more particularly to an illuminating and image capturing device to facilitate the examination of a person's oral cavity.

(b) Description of the Prior Art

Recently, various kinds of cameras or similar image capturing devices have been widely applied in the clinical examination of a patient's oral cavity. Obscure areas and details inside the oral cavity can be revealed by projecting the output of the image capturing device to a display. The clinical process can also be recorded and stored, along with the voices of doctors and patients, for documentation and education purpose.

A conventional image capturing device for this purpose usually has integrated light source and has to be placed inside the patient's mouth during its operations. This way of usage adds to the patient's uncomfortableness and chances of being infected. For the latter, the device is usually wrapped inside some plastic and transparent cover, causing even more uncomfortableness and blurring the images captured by the device. The cleaning and maintenance of the device therefore require special attention and care. Furthermore, the device may get in the way of the operation of other medical equipments inside the mouth and may require the assistance of an assistant, further reducing the convenience and desirability of the device's clinical usage.

### SUMMARY OF THE INVENTION

The primary purpose of the present invention is to provide an illuminating and image capturing device to obviate the foregoing shortcomings of conventional image capturing devices used in the clinical examination of oral cavity.

A major objective of the present invention is to combine an external light source with the image capturing device so as to provide illumination and image capture simultaneously into the oral cavity. As the present invention is not placed inside a patient's mouth, the patient's uncomfortableness and infection can be avoided. It also will not interfere with the operation of other medical equipment and requires very little effort in cleaning and maintenance.

Another objective of the present invention is that the illuminating and image capturing device can be operated by the doctor alone without any support of an assistant.

To achieve the foregoing objectives, the present invention mainly contains an illuminating component providing a shadowless lighting and an image capturing component installed on a transparent cover in front of the illuminating component. The image capturing component is connected to a display for presenting its captured images and/or other devices for recording or other functions. With the additional help of a handheld mouth mirror, all details of the oral cavity can be captured and presented on the display.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an illuminating and image capturing device according to an embodiment of the present invention.

FIG. 2 is a perspective view showing the illuminating and image capturing device of FIG. 1 after its assembly.

FIG. 3 is a perspective view showing an application scenario of the illuminating and image capturing device of FIG. 1.

FIG. 4 is a perspective view showing an illuminating and image capturing device according to another embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims

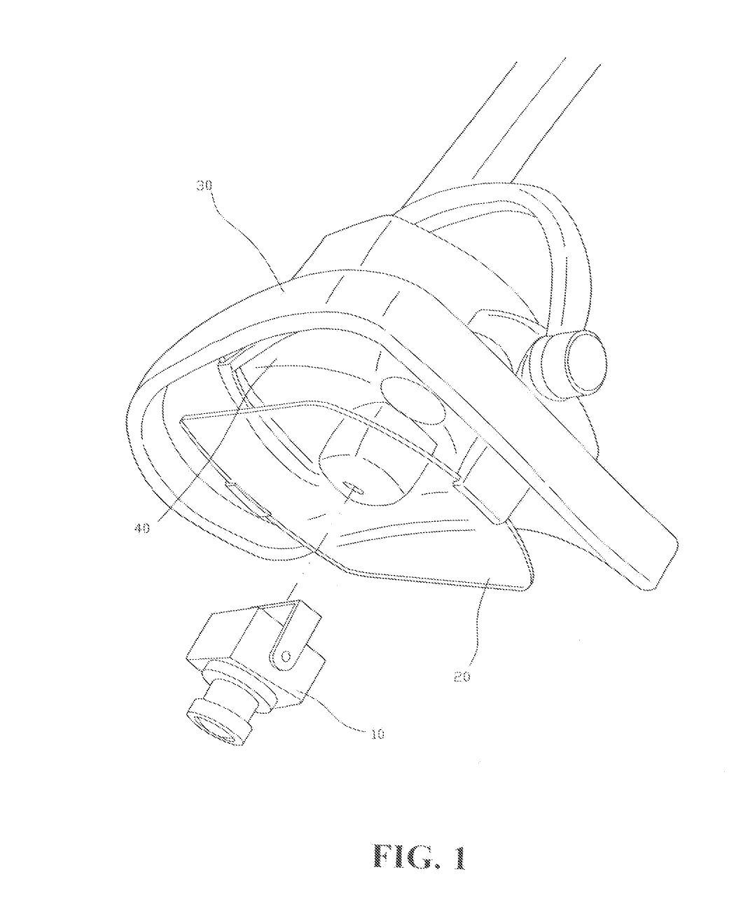

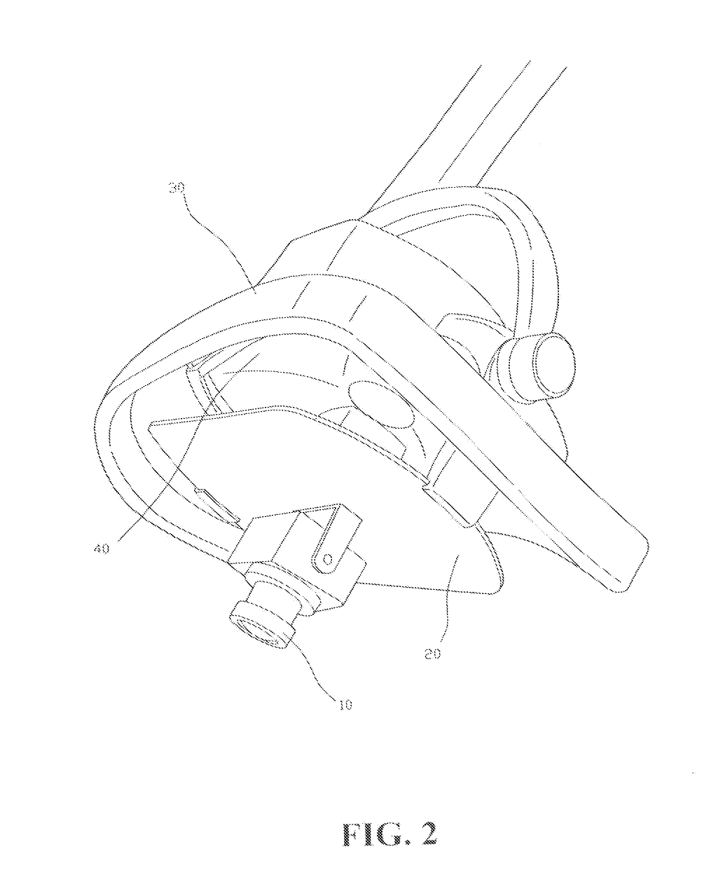

As shown in FIGS. 1 and 2, an embodiment of the present invention mainly contains an illuminating component 30 and an image capturing component 10. The illuminating component 30 contains a parabolic reflective mirror 40, a lamp unit (not shown) in front of the reflective mirror 40, and a transparent cover 20 in front of the lamp unit to prevent the lamp unit to emit light directly into a patient's eyes.

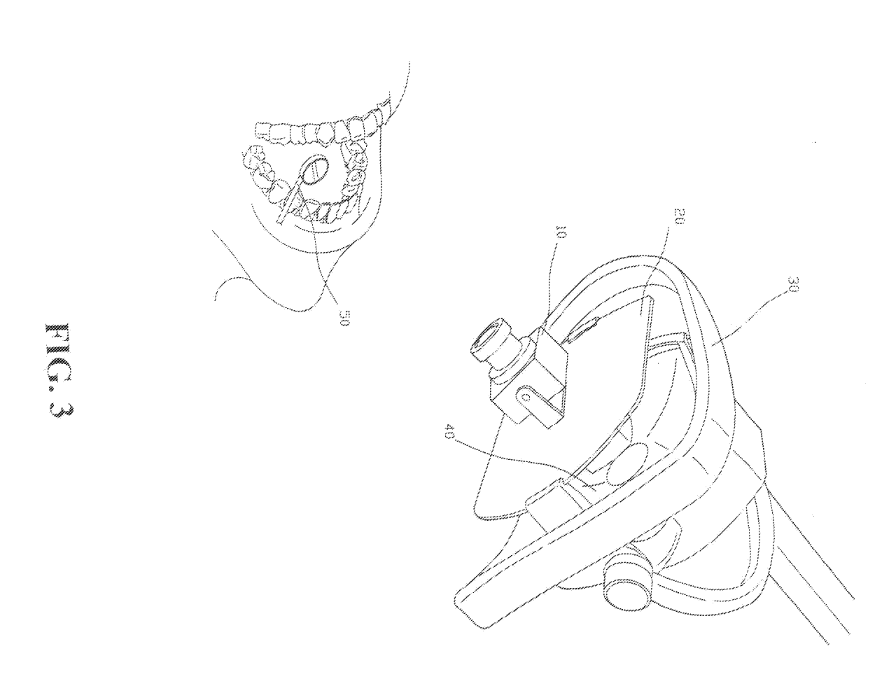

The image capturing component 10 is installed on the transparent cover 20 in front of the lamp unit. As the parabolic reflective mirror 40 distributes the light from the lamp unit into collimated light beams, the image capturing component 10 renders limited blocking to the light beams from the reflective mirror 40. As shown in FIG. 3, with the additional help of the reflection of a handheld mouth mirror 50 operated by the doctor, all details of the patient's oral cavity can be fully explored and captured by the image capturing component 10 under the shadowless lighting of the illuminating component 30. The image capturing component 10 is usually connected to a display (not shown) through appropriate cabling for presenting its captured images and/or other devices for recording or other functions.

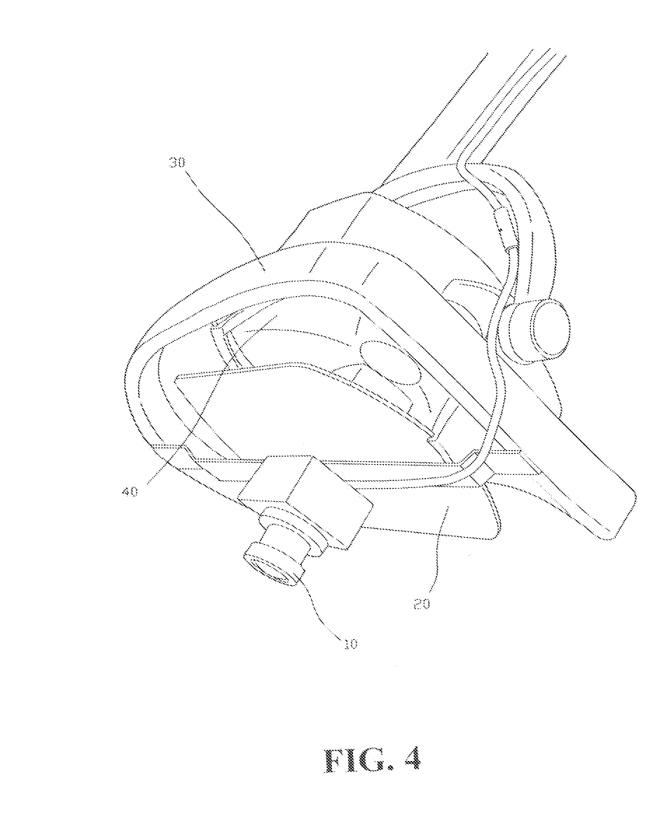

FIG. 4 presents another embodiment of the present invention, where the image capturing component 10 is installed on a frame (not numbered) of the illuminating component 30. Additionally, an voice collection component such as a common microphone device (not shown) can be integrated with the image capturing component 10 and the captured video signal and the audio signal collected by the microphone can be recorded synchronously on another device (not shown) via appropriate cabling.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An illuminating and image capturing device for oral cavity, comprising:
an illuminating component having a parabolic reflective mirror and a lamp unit in front of said reflective mirror; and
an image capturing component installed in front of said illuminating component;

2. The illuminating and image capturing device according to claim 1, wherein said illuminating component has a transparent cover in front of said lamp unit; and said image capturing component is installed on said transparent cover.

3. The illuminating and image capturing device according to claim 1, wherein said illuminating component has a frame in front of said lamp unit; and said image capturing component is installed on said frame.

4. The illuminating and image capturing device according to claim 1, further comprising a voice collection component for collecting audio signal.
